(19) United States
(12) Patent Application Publication
(10) Pub. No.: US 2023/0219464 A1
(43) Pub. Date: Jul. 13, 2023

(54) SEAT CONTROL DEVICE AND SEAT CONTROL METHOD

(71) Applicants: Hidekazu IMAI, Aichi (JP); Koji OZAWA, Aichi (JP); Yota KATAYAMA, Aichi (JP)

(72) Inventors: Hidekazu IMAI, Aichi (JP); Koji OZAWA, Aichi (JP); Yota KATAYAMA, Aichi (JP)

(73) Assignee: NIDEC MOBILITY CORPORATION, Aichi (JP)

(21) Appl. No.: 18/153,318

(22) Filed: Jan. 11, 2023

(30) Foreign Application Priority Data
Jan. 12, 2022 (JP) 2022-003053

(51) Int. Cl. B60N 2/02; B60N 2/06; B60N 2/00

(52) U.S. Cl. CPC B60N 2/0232; B60N 2/06; B60N 2/002; B60N 2002/0272

(57) ABSTRACT

A seat control device is a control device of an electric seat. The seat control device includes: a control unit configured to control an operation of the seat; a pinching detection unit configured to detect pinching of an object occurring while the seat is moving; and a seating detection unit configured to detect whether or not an occupant is seated on the seat. In a case in which the pinching detection unit detects pinching and the seating detection unit does not detect seating of the occupant, the control unit moves the seat in a reverse direction by a predetermined amount. In a case in which the pinching detection unit detects pinching and the seating detection unit detects seating of the occupant, the control unit moves the seat in the reverse direction by an amount smaller than the predetermined amount.

### CROSS-REFERENCE TO RELATED APPLICATIONS

This application is based upon and claims the benefit of priority from Japanese Patent Application No. 2022-003053, filed on Jan. 12, 2022; the entire contents of which are incorporated herein by reference.

### FIELD

One or more embodiments of the present invention relate to a device configured to control an electric seat equipped in a vehicle or the like, and particularly to a seat control device having a function of detecting pinching of foreign object.

### BACKGROUND

Some vehicles such as four-wheeled motor vehicles are equipped with an electric seat in which a seat portion and a backrest portion are moved back and forth by rotation of a motor. In such a seat, in a related art, when adjusting the positions of the seat portion and the backrest portion, the positions are adjusted by operating an operation unit provided near the seat. On the other hand, in recent years, a vehicle is introduced with an automatic driving function of registering the position of the seat portion or backrest portion in advance as a target position according to a user's preference and automatically moving the seat portion and backrest portion to the target position when the user gets in the vehicle.

In a vehicle with such an automatic driving function, for example, in a state in which there is a person or object between the front seat and the rear seat, when the seat portion of the front seat is automatically moved backward (straight forward), it is unsafe that the person or object is pinched between the front seat and the rear seat. The same applies to the case in which the backrest portion of the front seat automatically moves (tilts) backward. Therefore, a seat control device is required to have a function of quickly detecting pinching and reversing the seat portion or the backrest portion in the direction opposite to the movement direction to recover from the pinching.

When pinching occurs, the current flowing through the motor increases and the rotation speed of the motor decreases as the load applied to the motor increases. Therefore, it is possible to determine whether or not pinching has occurred by detecting the amount of change (difference) in the current or rotation speed of the motor in a predetermined period and comparing the detected value with a threshold value. KR10-2020-0065312A, KR10-2020-0065302A, KR10-2013-0039104A, CN109278594A, JP2016-129449A, and JP2007-131138A discloses a pinching detection technique in seat position control. JP2004-210159A describes a control method of a seat position when pinching is detected, which occurs when a seat cushion is flipped up. JP2021-095085A describes a technique for preventing a seat from becoming incapable of being driven by increasing a threshold value for detection of pinching in a case in which an occupant is seated on a seat.

FIGS. 8A to 8C and FIGS. 9A to 9C show basic operations in a case in which pinching caused by an electric seat 30 has occurred. The seat 30 includes a seat portion 31 that can move straight in the front-and-rear direction, and a backrest portion 32 that can tilt in the front-and-rear direction. The arrow F indicates the forward direction, and the arrow R indicates the backward direction. Hereinafter, the straight operation of the seat portion 31 in the front-and-rear direction will be referred to as a “sliding operation”, and the tilting operation of the backrest portion 32 in the front-and-rear direction will be referred to as a “reclining operation”.

FIGS. 8A to 8C show cases in which pinching has occurred during the sliding operation of the seat portion 31. FIG. 8A shows the state before the sliding operation, in which the front seat (here, the driver's seat) 30 on which an occupant 50 is seated is positioned at a certain distance from a rear seat 40 on which an occupant 60 is seated.

In this state, when the occupant 50 performs an automatic operation to automatically move the seat portion 31 to a predetermined position (target position) in the backward direction R, the seat portion 31 moves in the P direction by the sliding operation as shown in FIG. 8B, and the backrest portion 32 also moves in conjunction with the seat portion 31. That is, the entire seat 30 moves in the backward direction R. At this time, if the target position is close to the rear seat 40, a part of the seat 30 that is moving hits the legs of the occupant 60 on the rear seat, as indicated by the dashed line a. As a result, the seat 30 cannot move any further, and the legs are pinched between the seats 30 and 40. X1 indicates the position of the seat portion 31 when pinching occurs. When this pinching is detected, the motor temporarily stops in the state in FIG. 8B, and then rotates in reverse. Therefore, the seat portion 31 of the seat 30 is reversed from the pinching position X1 and moves in the P′ direction opposite to the P direction as shown in FIG. 8C. As a result, the space between the seats 30 and 40 is widened, and the legs of the occupant 60 are recovered from the pinching.

FIGS. 9A to 9C shows cases in which pinching has occurred during the reclining operation of the backrest portion 32. FIG. 9A shows the state before the reclining operation, in which the front seat 30 on which the occupant 50 is seated is positioned at a certain distance from the rear seat 40. A luggage W is placed between the front seat 30 and the rear seat 40.

In this state, when the occupant 50 performs an automatic operation to automatically move the backrest portion 32 to a predetermined position (target position) in the backward direction R, the backrest portion 32 moves in the Q direction by the reclining operation as shown in FIG. 9B (the seat portion 31 does not move). At this time, if the tilt angle of the backrest portion 32 is equal to or greater than a certain value, the backrest portion 32 that is moving hits the luggage W as indicated by the dashed line b. As a result, the backrest portion 32 cannot move any further, and the luggage W is pinched between the seats 30 and 40. Y1 indicates the position of the backrest portion 32 when pinching occurs. When this pinching is detected, the motor temporarily stops in the state in FIG. 9B, and then rotates in reverse. Therefore, the backrest portion 32 is reversed from the pinching position Y1 and moves in the Q′ direction opposite to the Q direction as shown in FIG. 9C. As a result, the space between the seats 30 and 40 is widened, and the luggage W is recovered from the pinching.

However, in the case of FIGS. 8A to 8C, if the movement amount of the seat portion 31 after being reversed is large, a movement distance C from the pinching position X1 of the seat portion 31 to a stop position X4 increases as shown in FIG. 10, and a situation occurs in which the legs of the occupant 50 on the front seat are pinched between a dashboard 71 and the seat portion 31 as indicated by the dashed line c.

Also in the case of FIGS. 9A to 9C, if the movement amount of the backrest portion 32 after being reversed is large, as shown in FIG. 11, a movement angle θc of the backrest portion 32 from the pinching position Y1 to a stop position Y4 increases as shown in FIG. 11, and a situation occurs in which the occupant 50 on the front seat is pinched between a steering wheel 72 and the backrest portion 32 as indicated by the dashed line d.

### SUMMARY

An object of one or more embodiments of the present invention is to prevent the safety of an occupant from being threatened by the reversing operation of a seat in a case in which pinching caused by an electric seat has occurred.

A seat control device according to one or more embodiments of the present invention is a control device of an electric seat configured to automatically move to a target position based on a predetermined operation, the seat control device including: a control unit configured to control the operation of the seat; a pinching detection unit configured to detect pinching of an object occurring while the seat is moving; and a seating detection unit configured to detect whether or not an occupant is seated on the seat. The control unit moves the seat in a reverse direction by a predetermined amount in a case in which the pinching detection unit detects pinching and the seating detection unit does not detect that the occupant is seated. Further, the control unit moves the seat in the reverse direction by an amount smaller than the predetermined amount in a case in which the pinching detection unit detects pinching and the seating detection unit detects seating of the occupant.

In this way, in a case in which pinching caused by the seat is detected, if the occupant is seated on the seat, the movement amount of the seat in the reverse direction is smaller than in the case in which the occupant is not seated. Therefore, it is possible to avoid a situation in which pinching of the occupant seated on the seat occurs next time (FIGS. 10 and 11) by the reversing operation of the seat, and the safety of the occupant is secured.

As a first control mode of one or more embodiments of the present invention, it is conceivable that the first control unit may control the operation of the seat portion that is provided in the seat and configured to move straight in a front-and-rear direction. In this case, the first control unit may move the seat portion in the reverse direction by a predetermined distance in a case in which the pinching detection unit detects pinching and the seating detection unit does not detect seating of the occupant. Further, the first control unit may move the seat portion in the reverse direction by a distance smaller than the predetermined distance in a case in which the pinching detection unit detects pinching and the seating detection unit detects seating of the occupant.

As a second control mode according to one or more embodiments of the present invention, it is conceivable that the second control unit may control the operation of the backrest portion that is provided in the seat and configured to tilt in the front-and-rear direction. In this case, the second control unit may move the backrest portion by a predetermined angle in the reverse direction in a case in which the pinching detection unit detects pinching and the seating detection unit does not detect seating of the occupant. Further, the second control unit may move the backrest portion in the reverse direction by an angle smaller than the predetermined angle in a case in which the pinching detection unit detects pinching and the seating detection unit detects seating of the occupant.

According to one or more embodiments of the present invention, in a case in which pinching is detected, if the occupant is seated, since the movement amount of the seat in the reverse direction is restricted, the safety of the occupant is prevented from being threatened by the reversing operation of the seat.

### BRIEF DESCRIPTION OF DRAWINGS

FIG. 1 is a block diagram of an electric seat system including a seat control device of one or more embodiments of the present invention;

FIGS. 2A to 2C are diagrams showing an operation in a case in which a front seat is not taken in a first embodiment;

FIGS. 3A to 3C are diagrams showing an operation in a case in which the front seat is taken in the first embodiment;

FIG. 4 is a flow chart showing a control procedure of the first embodiment;

FIGS. 5A to 5C are diagrams showing an operation in a case in which a front seat is not taken in a second embodiment;

FIGS. 6A to 6C are diagrams showing an operation in a case in which the front seat is taken in the second embodiment;

FIG. 7 is a flow chart showing a control procedure of the second embodiment.

FIGS. 8A to 8C are diagrams for describing pinching due to the movement of a seat portion;

FIGS. 9A to 9C are diagrams for describing pinching due to the movement of a backrest portion;

FIG. 10 is a diagram for describing problems in the case of FIGS. 8A to 8C; and

FIG. 11 is a diagram for describing problems in the case of FIGS. 9A to 9C.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention. Embodiments of the present invention will be described with reference to drawings. The same reference numerals are used throughout the drawings to refer to the same or corresponding parts. In the following, an example in which a seat control device mounted on a vehicle will be given.

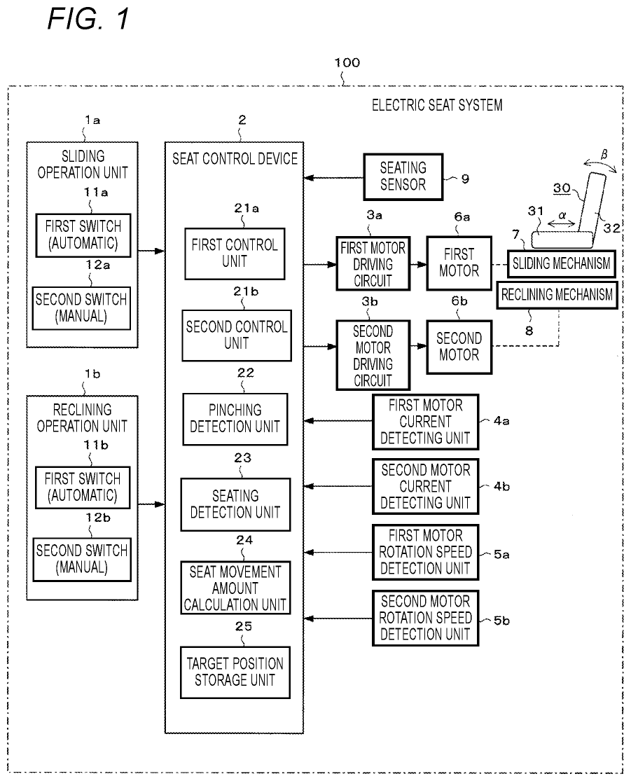

FIG. 1 shows an example of a seat control device 2 according to one or more embodiments of the present invention and an electric seat system 100 using the same. The electric seat system 100 is installed in a vehicle such as a four-wheeled motor vehicle. The electric seat system 100 includes a sliding operation unit 1a, a reclining operation unit 1b, a seat control device 2, a first motor driving circuit 3a, a second motor driving circuit 3b, a first motor current detecting unit 4a, a second motor current detecting unit 4b, a first motor rotation speed detection unit 5a, a second motor rotation speed detection unit 5b, a first motor 6a, a second motor 6b, a sliding mechanism 7, a reclining mechanism 8, a seating sensor 9, and a seat 30. The seat 30 is an electric seat driven by the motors 6a and 6b.

The sliding operation unit 1a is provided with two switches 11a and 12a. The first switch 11a is an automatic drive switch that is operated when the seat portion 31 of the seat 30 is automatically slid to a target position in a a direction. The second switch 12a is a manual drive switch that is operated when the seat portion 31 is manually slid to an arbitrary position in the a direction.

The reclining operation unit 1b is also provided with two switches 11b and 12b. The first switch 11b is an automatic drive switch that is operated when the backrest portion 32 of the seat 30 is automatically reclined to a target position in a β direction. The second switch 12b is a manual drive switch that is operated when the backrest portion 32 is manually reclined to an arbitrary position in the β direction.

The seat control device 2 includes a first control unit 21a, a second control unit 21b, a pinching detection unit 22, a seating detection unit 23, a seat movement amount calculation unit 24, and a target position storage unit 25.

The first control unit 21a outputs a control signal for controlling the rotation of the first motor 6a to the first motor driving circuit 3a based on the operation state of each of the switches 11a and 12a of the sliding operation unit 1a, the detection result of the pinching detection unit 22, the detection result of the seating detection unit 23, and the movement amount of the seat portion 31 calculated by the seat movement amount calculation unit 24, and the like.

The second control unit 21b outputs a control signal for controlling the rotation of the second motor 6b to the second motor driving circuit 3b based on the operation state of each of the switches 11b and 12b of the reclining operation unit 1b, the detection result of the pinching detection unit 22, the detection result of the seating detection unit 23, and the movement amount of the backrest portion 32 calculated by the seat movement amount calculation unit 24, and the like.

The pinching detection unit 22 detects pinching of an object by the seat 30 based on the currents of the second motors 6a and 6b detected by the current detecting units 4a and 4b, respectively. The details of pinching detection based on the motor current are well known and will not be described.

The seating detection unit 23 detects whether or not an occupant is seated on the seat 30 based on the detection signal from the seating sensor 9.

The seat movement amount calculation unit 24 calculates the respective movement amounts of the seat portion 31 and the backrest portion 32 based on the rotation speeds of the motors 6a and 6b respectively detected by the motor rotation speed detection units 5a and 5b. The movement amount of the seat portion 31 is a distance, and the movement amount of the backrest portion 32 is an angle. The motor rotation speed detection units 5a and 5b are composed of, for example, rotation sensors that output pulse signals in synchronization with the rotation of the motors 6a and 6b.

The target position storage unit 25 stores target positions when the seat 30 is automatically driven by the first switches 11a and 11b of the operation units 1a and 1b. After adjusting the positions of the seat portion 31 and the backrest portion 32 to desired positions by operating the second switches 12a and 12b of the respective operation units 1a and 1b, the positions are stored in the target position storage unit 25 as target positions by operating a setting switch not shown in the drawing.

The seat control device 2 is composed of a microcomputer, and respective functions of the first control unit 21a, the second control unit 21b, the pinching detection unit 22, the seating detection unit 23, and the seat movement amount calculation unit 24 are actually realized by software, but in this case, the functions are illustrated as blocks of hardware for convenience.

The first motor driving circuit 3a generates a drive voltage for rotating the first motor 6a and supplies the drive voltage to the first motor 6a. The first motor 6a is rotated by this drive voltage, and causes the seat portion 31 of the seat 30 to slide in the a direction via the sliding mechanism 7. The sliding mechanism 7 is connected to the first motor 6a and the seat portion 31, and converts the rotary motion of the first motor 6a into linear motion.

The second motor driving circuit 3b generates a drive voltage for rotating the second motor 6b and supplies the drive voltage to the second motor 6b. The second motor 6b is rotated by this drive voltage, and causes the backrest portion 32 of the seat 30 to recline in the β direction via the reclining mechanism 8. The reclining mechanism 8 is connected to the second motor 6b and the backrest portion 32, and transmits the rotation of the second motor 6b to the backrest portion 32 via gears or the like. The seating sensor 9 is composed of, for example, a pressure sensor provided in the seat portion 31 of the seat 30, and outputs a detection signal corresponding to whether or not the occupant is seated.

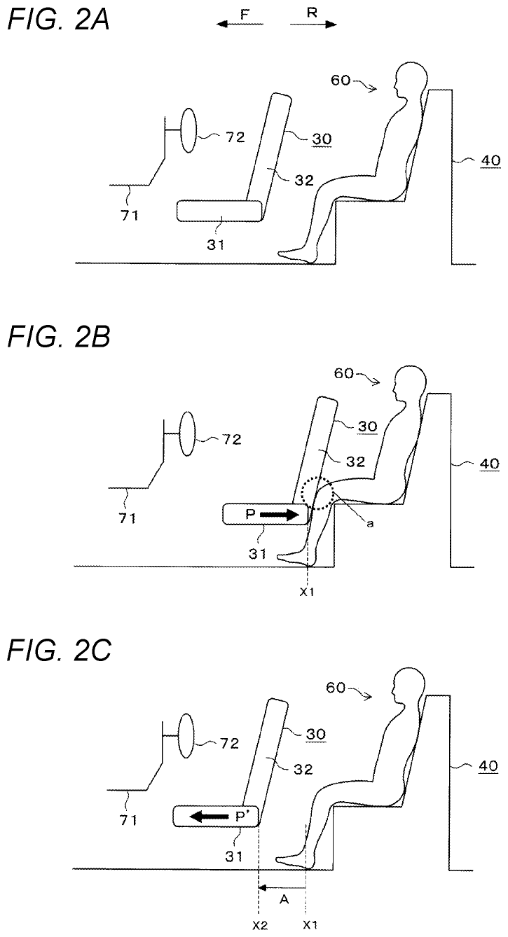

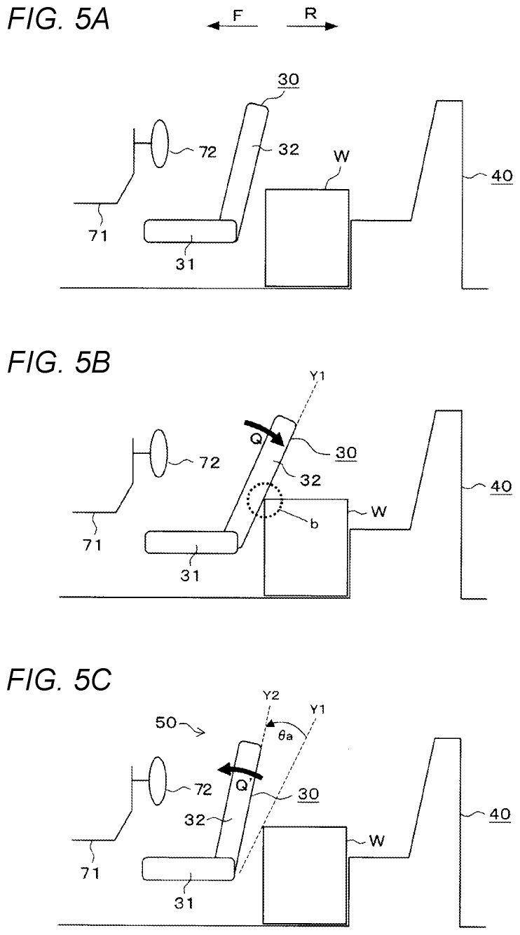

Next, the operation in a case in which pinching has occurred due to the movement of the seat 30 will be described. FIGS. 2A to 4 show the operation of the first embodiment in a case in which pinching has occurred due to the movement of the seat portion 31. FIGS. 5A to 7 show the operation of the second embodiment in a case in which pinching has occurred due to the movement of the backrest portion 32.

First, the operation of the first embodiment will be described. FIGS. 2A to 2C show the operation in a case in which the occupant is not seated on the seat 30 when pinching occurs by the seat portion 31.

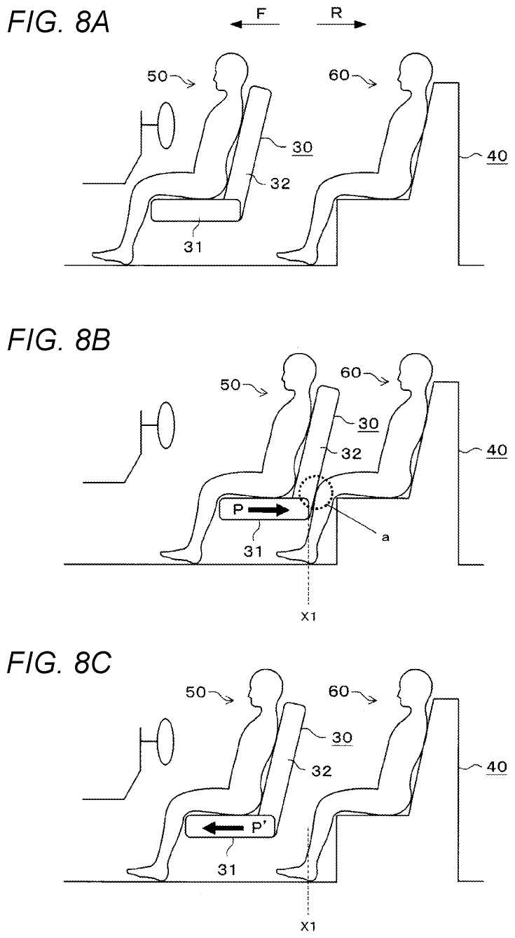

FIG. 2A shows the state before operation (that is, the state before pinching occurs), in which the front seat 30 on which no occupant is seated is positioned at a certain distance from the rear seat 40. In this state, when the first switch 11a of the sliding operation unit 1a is operated by an occupant outside the door or on the assistant seat, the seat portion 31 moves in the P direction toward the target position by the sliding operation as shown in FIG. 2B. At this time, the backrest portion 32 also moves in conjunction with the seat portion 31. When the target position is close to the rear seat 40 and the movement distance of the seat portion 31 is long, the legs of the occupant 60 on the rear seat are pinched between the seats 30 and 40 as indicated by the dashed line a. X1 indicates the position of the seat portion 31 when pinching occurs (same as in FIGS. 8A to 8C).

When this pinching is detected by the pinching detection unit 22, the first control unit 21a outputs a stop command signal to the first motor driving circuit 3a to temporarily stop the first motor 6a for sliding operation. As a result, the seat portion 31 temporarily stops at the pinching position X1 in FIG. 2B.

Thereafter, the first control unit 21a outputs a reverse rotation command signal to the first motor driving circuit 3a to rotate the first motor 6a in reverse. Therefore, the seat portion 31 is reversed from the pinching position X1 in FIG. 2B, moves by a predetermined distance A in the P′ direction opposite to the P direction as shown in FIG. 2C, and stops at a stop position X2. As a result, the space between the seats 30 and 40 is widened, and the legs of the occupant 60 are recovered from the pinching.

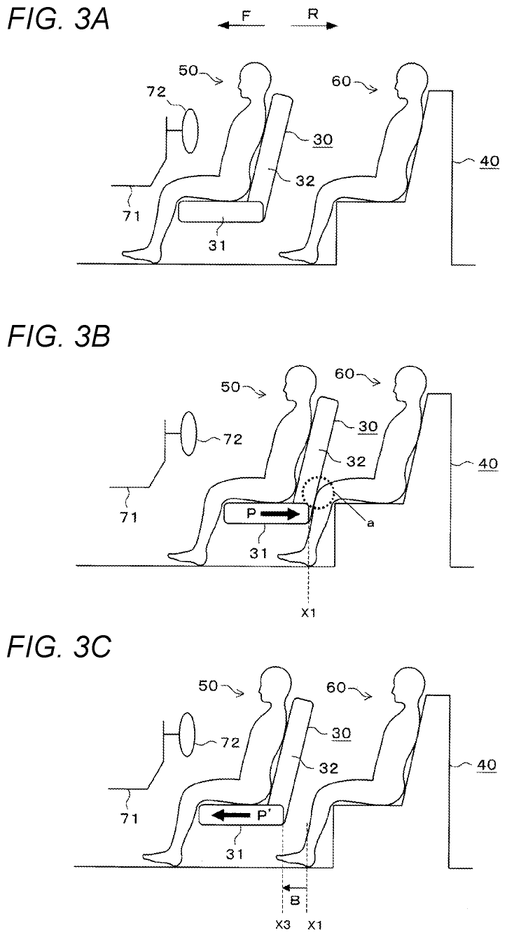

FIGS. 3A to 3C show the operation in a case in which an occupant is seated on the seat 30 when pinching caused by the seat portion 31 occurs.

FIG. 3A shows a state before operation, which is the same as FIG. 2A except that the occupant 50 is seated on the seat 30. FIG. 3B shows a state in which pinching has occurred, which is the same as FIG. 2B except that the occupant 50 is seated on the seat 30.

When pinching is detected by the pinching detection unit 22, as in the case of FIGS. 2A to 2C, the seat portion 31 temporarily stops at the pinching position X1 in FIG. 3B, and then reversed, and moves in the P′ direction as shown in FIG. 3C. At this time, the seat portion 31 moves from the pinching position X1 by a distance B shorter than the distance A shown in FIG. 2C and stops at a stop position X3. As a result, the space between the seats 30 and 40 is widened, and the legs of the occupant 60 are recovered from the pinching.

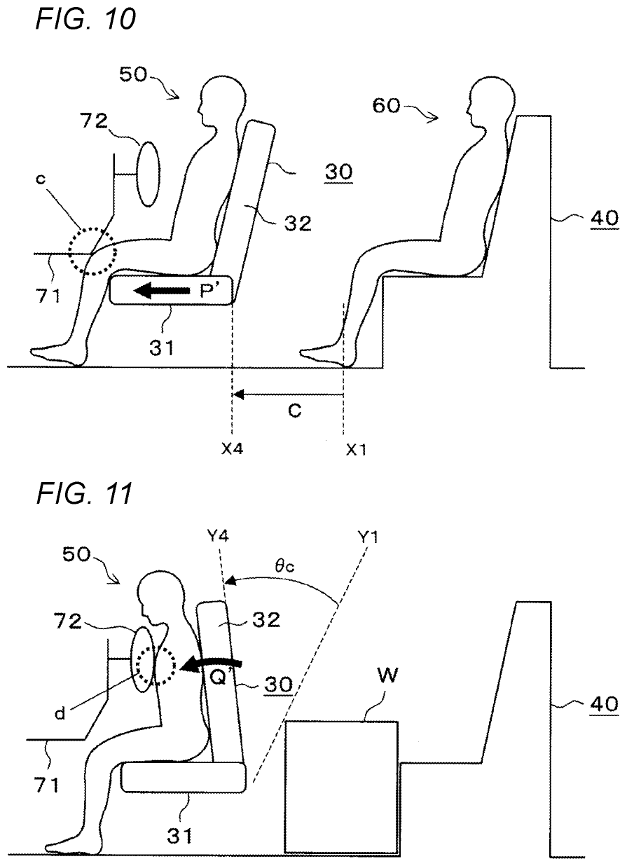

Here, it is preferable that the distance B is selected as a distance to form a space between both the seats 30 and 40 to the extent that there is no hindrance to the movement or getting off of the occupant 60 on the rear seat such that the occupant 50 on the front seat does not collide with the dashboard 71 or the steering wheel 72. By selecting the distance B in this way, even if the distance B is short (B<A), the movement or getting off of the occupant 60 in the rear seat is not hindered, and the next occurrence of pinching of the occupant 50 on the front seat as shown in FIG. 10 can be avoided.

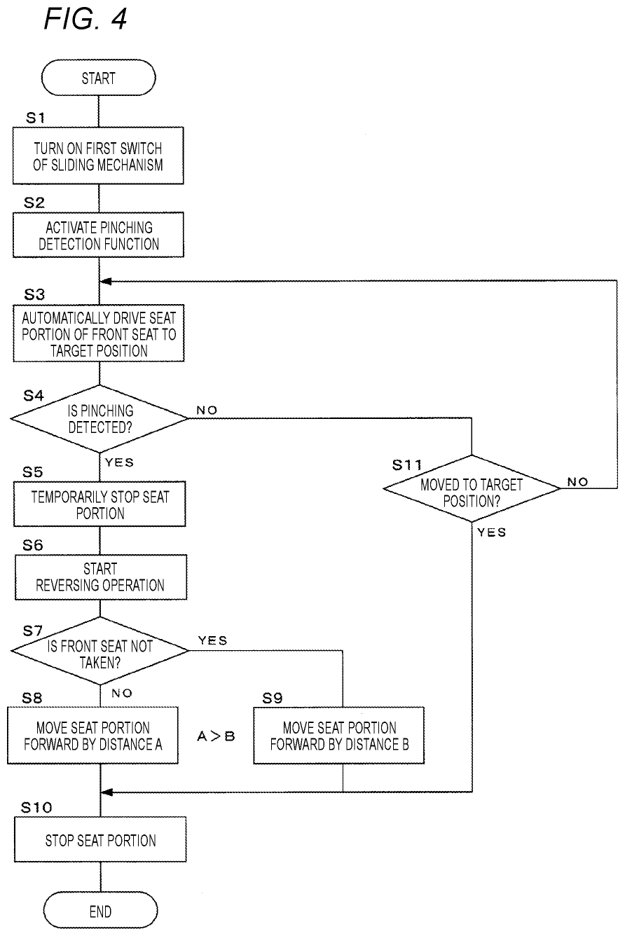

FIG. 4 is a flow chart showing a control procedure by the first control unit 21a of the seat control device 2 in the first embodiment described above.

When the first switch 11a of the sliding operation unit 1a is operated in step S1, the function of detecting pinching of the pinching detection unit 22 is activated in step S2. In the subsequent step S3, under the control of the first control unit 21a, the first motor driving circuit 3a operates to rotate the first motor 6a, thereby an automatic driving is performed by moving the seat portion 31 of the front seat 30 to the target position.

Thereafter, in step S4, it is determined whether or not pinching due to the sliding operation of the seat portion 31 is detected by the pinching detection unit 22. In a case in which pinching is not detected, the process proceeds to step S11 to determine whether or not the seat portion 31 has moved to the target position, and if the seat portion 31 has not moved to the target position, the automatic driving is continued by returning to step S3. Then, when the seat portion 31 moves to the target position, the process proceeds to step S10, the first motor 6a stops, and the seat portion 31 also stops.

On the other hand, in a case in which pinching by the seat portion 31 is detected in step S4, the process proceeds to step S5, the first motor 6a is temporarily stopped, and the seat portion 31 is temporarily stopped. Subsequently, in step S6, the first motor 6a is rotated in reverse to start the reversing operation of the seat portion 31, that is, the movement in the P′ direction in FIGS. 2A to 2C and FIGS. 3A to 3C.

Next, in step S7, it is determined whether or not the occupant 50 is seated on the front seat 30 based on the detection result of the seating detection unit 23. As a result of the determination, in a case in which the occupant 50 is not seated on the seat 30, the process proceeds to step S8, and the seat portion 31 is moved forward (in the P′ direction) by the distance

A (see FIG. 2C). When this movement ends, the process proceeds to step S10, the first motor 6a stops, and the seat portion 31 also stops.

As a result of the determination in step S7, in a case in which the occupant 50 is seated on the seat 30, the process proceeds to step S9, and the seat portion 31 is moved forward (in the direction of P′) by the distance B (see FIG. 3C). When this movement ends, the process proceeds to step S10, the first motor 6a stops, and the seat portion 31 also stops.

As described above, in the first embodiment, in a case in which pinching by the seat portion 31 is detected, if the occupant 50 is not seated, the reverse movement amount (distance A) of the seat portion 31 is increased, and if the occupant 50 is seated, the reverse movement amount (distance B) of the seat portion 31 is reduced. Therefore, in a case in which the occupant 50 is not seated on the front seat 30, since a sufficient space is secured between the seat 30 and the seat 40 by the reversing of the seat portion 31, the movement and the getting off of the occupant 60 on the rear seat are facilitated. On the other hand, in a case in which the occupant 50 is seated on the front seat 30, since the movement distance is short even when the seat portion 31 is reversed, the occurrence of pinching in the front seat as shown in FIG. 10 can be avoided, and the safety of the occupant 50 can be secured.

Next, the operation of the second embodiment will be described. FIGS. 5A to 5C show the operation in a case in which the occupant is not seated on the seat 30 when pinching occurs by the backrest portion 32.

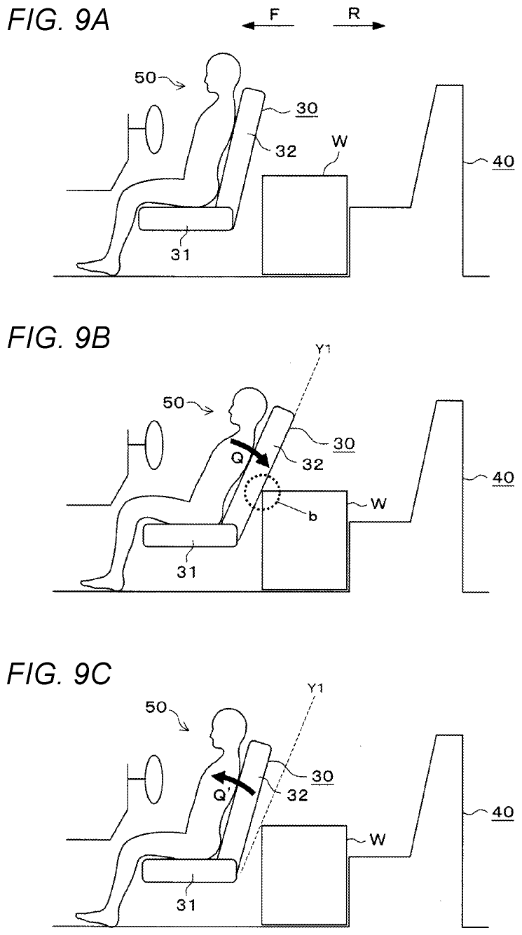

FIG. 5A shows the state before operation (that is, the state before pinching occurs), in which the front seat 30 on which no occupant is seated, is positioned at a certain distance from the rear seat 40. The luggage W is placed between the seat 30 and the seat 40. In this state, when the first switch 11b of the reclining operation unit 1b is operated by an occupant outside the door or on the assistant seat, the backrest portion 32 moves in the Q direction toward the target position by the reclining operation as shown in FIG. 5B. At this time, the seat portion 31 does not move. When the tilt angle of the backrest portion 32 to the target position is large, the backrest portion 32 that is moving hits the luggage W, and the luggage W is pinched between the two seats 30 and 40, as indicated by the dashed line b. Y1 indicates the position of the seat portion 31 when pinching occurs (same as in FIGS. 9A to 9C).

When the pinching is detected by the pinching detection unit 22, the second control unit 21b outputs a stop command signal to the second motor driving circuit 3b to temporarily stop the second motor 6b for reclining operation. As a result, the backrest portion 32 temporarily stops at the pinching position Y1 in FIG. 5B.

Thereafter, the second control unit 21b outputs a reverse rotation command signal to the second motor driving circuit 3b to rotate the second motor 6b in reverse. Therefore, the backrest portion 32 is reversed from the pinching position Y1 in FIG. 5B, moves in the Q′ direction opposite to the Q direction by a predetermined angle θa as shown in FIG. 5C, and stops at a stop position Y2. As a result, the space between the seats 30 and 40 is widened, and the luggage W is recovered from the pinching.

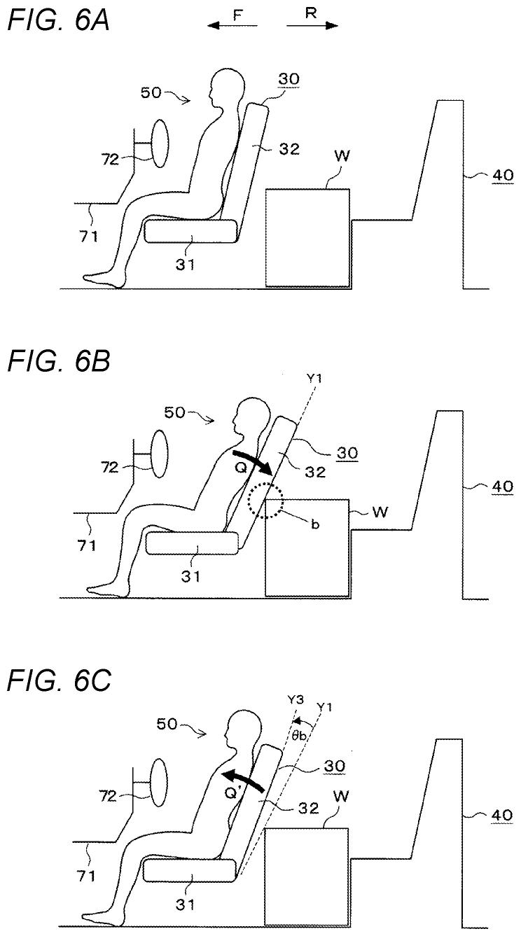

FIGS. 6A to 6C show the operation in a case in which the occupant is seated on the seat 30 when pinching occurs by the backrest portion 32.

FIG. 6A shows a state before operation, which is the same as FIG. 5A except that the occupant 50 is seated on the seat 30. FIG. 6B shows a state in which pinching has occurred, which is the same as FIG. 5B except that the occupant 50 is seated on the seat 30.

When pinching is detected by the pinching detection unit 22, as in the case of FIGS. 5A to 5C, the backrest portion 32 temporarily stops at the pinching position Y1 in FIG. 6B, and then is reversed and moves in the Q′ direction as shown in FIG. 6C. In this case, the backrest portion 32 moves from the pinching position Y1 by an angle θb smaller than the angle θa shown in FIG. 5C and stops at a stop position Y3. As a result, the space between the seats 30 and 40 is widened, and the luggage W is recovered from the pinching.

Here, it is preferable that the angle θb is selected as an angle to form a space between both the seats 30 and 40 to the extent that there is no hindrance to the movement and taking out of the luggage W such that the occupant 50 on the front seat does not collide with the dashboard 71 or the steering wheel 72. By selecting the angle θb in this way, even if the angle θb is small (θb<θa), there is no hindrance to the movement or taking out of the luggage W, and the next occurrence of pinching of the occupant 50 on the front seat as shown in FIG. 11 can be avoided.

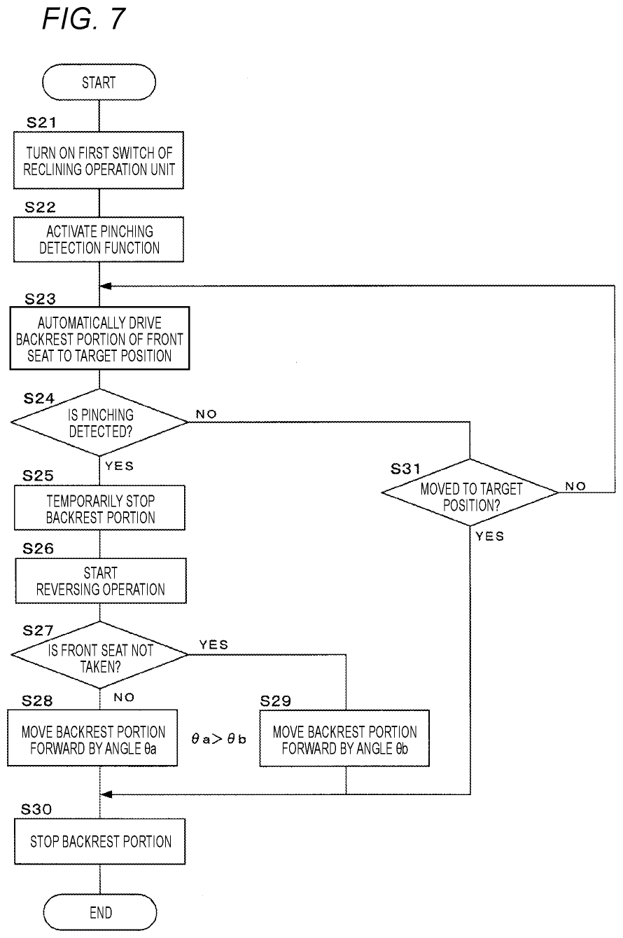

FIG. 7 is a flow chart showing a control procedure by the second control unit 21b of the seat control device 2 in the second embodiment described above.

When the first switch 11b of the reclining operation unit 1b is operated in step S21, the function of detecting pinching by the pinching detection unit 22 is activated in step S22. In the subsequent step S23, under the control of the second control unit 21b, the second motor driving circuit 3b operates to rotate the second motor 6b, thereby an automatic driving is performed by moving the backrest portion 32 of the front seat 30 to the target position.

Thereafter, in step S24, it is determined whether or not the pinching detection unit 22 detects pinching due to the reclining operation of the backrest portion 32. In a case in which pinching is not detected, the process proceeds to step S31 to determine whether or not the backrest portion 32 has moved to the target position, and if the seat portion 31 has not moved to the target position, the automatic driving is continued by returning to step S23. Then, when the backrest portion 32 moves to the target position, the process proceeds to step S30, the second motor 6b stops, and the backrest portion 32 also stops.

On the other hand, in a case in which pinching by the backrest portion 32 is detected in step S24, the process proceeds to step S25, the second motor 6b is temporarily stopped, and the backrest portion 32 is temporarily stopped. Subsequently, in step S26, the second motor 6b is rotated in reverse to start the reversing operation of the backrest portion 32, that is, the movement in the Q′ direction in FIGS. 5A to 5C and FIGS. 6A to 6C.

Next, in step S27, it is determined whether or not the occupant 50 is seated on the front seat 30 based on the detection result of the seating detection unit 23. As a result of the determination, in a case in which the occupant 50 is not seated on the seat 30, the process proceeds to step S28, and the backrest portion 32 is moved forward (in the Q′ direction) by an angle θa (see FIG. 5C). When this movement ends, the process proceeds to step S30, the second motor 6b stops, and the backrest portion 32 also stops.

As a result of determination in step S27, in a case in which the occupant 50 is seated on the seat 30, the process proceeds to step S29, and the backrest portion 32 is moved forward (in the Q′ direction) by the angle θb (see FIG. 6C). When this movement ends, the process proceeds to step S30, the second motor 6b stops, and the backrest portion 32 also stops.

As described above, in the second embodiment, in a case in which pinching by the backrest portion 32 is detected, if the occupant 50 is not seated, the reverse movement amount (angle θa) of the backrest portion 32 is increased, and if the occupant 50 is seated, the reverse movement amount (angle θb) of the backrest portion 32 is reduced. Therefore, in a case in which the occupant 50 is not seated on the front seat 30, since a sufficient space is secured between the seat 30 and the seat 40 by the reversing of the backrest portion 32, the movement and the taking out of the luggage W is facilitated. On the other hand, in a case in which the occupant 50 is seated on the front seat 30, since the movement angle of the backrest portion 32 is small even when the backrest portion 32 is reversed, the occurrence of pinching in the front seat as shown in FIG. 11 can be avoided, and the safety of the occupant 50 can be secured.

In one or more embodiments of the present invention, various embodiments as described below can be adopted in addition to the embodiments described above.

In the above embodiment, the case in which pinching has occurred due to the sliding operation of the seat portion 31 and the case in which pinching has occurred due to the reclining operation of the backrest portion 32 are separately described, but one or more embodiments of the present invention can also be applied the case in which the sliding operation of the seat portion 31 and the reclining operation of the backrest portion 32 are simultaneously performed and pinching has occurred.

In the above-described embodiment, the case in which pinching has occurred between the front seat 30 and the rear seat 40 is taken as an example, but the present invention is not limited thereto. For example, in a vehicle equipped with three rows of seats, a front seat, a middle seat, and a rear seat, one or more embodiments of the present invention can also be applied to the case in which pinching has occurred between the front seat and the middle seat or the middle seat and the rear seat. Also, the front seat is not limited to the driver's seat, and may be the assistant seat.

In the above-described embodiment, in FIGS. 2A to 2C and FIGS. 3A to 3C, the legs of the occupant 60 on the rear seat is pinched as an example, but the object of the pinching may be the luggage W as shown in FIGS. 5A to 5C. Conversely, in FIGS. 5A to 5C and FIGS. 6A to 6C, the object of pinching may be the legs of the occupant 60 on the rear seat as shown in FIGS. 2A to 2C.

In the above embodiment, an example using a pressure sensor as the seating sensor 9 is taken, but the present invention is not limited thereto. For example, a heartbeat sensor, a blood pressure sensor, or the like provided in the seat 30 for monitoring the health condition of the occupant may be used as the seating sensor 9. As another means, whether or not the occupant is seated may be detected based on an image captured by a monitoring camera installed in the vehicle.

In the above embodiment, pinching is detected based on the motor current detected by the motor current detecting units 4a and 4b, but instead, pinching may be detected based on the rotation speed of the motors 6a and 6b detected by the motor rotation speed detection units 5a and 5b.

In the embodiment described above, in FIG. 1, the motor driving circuits 3a and 3b are provided outside the seat control device 2, but these motor driving circuits 3a and 3b may be included in the seat control device 2. The seat control device 2 may also include the motor current detecting units 4a and 4b, the motor rotation speed detection units 5a and 5b, the seating sensor 9, and the like.

In the above-described embodiments, the seat control device mounted on the vehicle is taken as an example, but one or more embodiments of the present invention can also be applied to seat control devices used in fields other than vehicles.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. A seat control device that is a control device of an electric seat that is configured to automatically move to a target position based on a predetermined operation, the seat control device comprising:
a control unit configured to control an operation of the seat;
a pinching detection unit configured to detect pinching of an object occurring while the seat is moving; and
a seating detection unit configured to detect whether or not an occupant is seated on the seat,
wherein in a case in which the pinching detection unit detects pinching and the seating detection unit does not detect seating of the occupant, the control unit moves the seat in a reverse direction by a predetermined amount, and
wherein in a case in which the pinching detection unit detects pinching and the seating detection unit detects seating of the occupant, the control unit moves the seat in the reverse direction by an amount smaller than the predetermined amount.

2. The seat control device according to claim 1,
wherein the control unit comprises a first control unit configured to control an operation of a seat portion provided in the seat, the seat portion being configured to move straight in a front-and-rear direction,
wherein in a case in which the pinching detection unit detects pinching and the seating detection unit does not detect seating of the occupant, the first control unit moves the seat portion in a reverse direction by a predetermined distance, and
wherein in a case in which the pinching detection unit detects pinching and the seating detection unit detects seating of the occupant, the first control unit moves the seat portion in the reverse direction by a distance smaller than the predetermined distance.

3. The seat control device according to claim 1,
wherein the control unit comprises a second control unit configured to control an operation of a backrest portion that is provided in the seat, the backrest portion being configured to tilt in a front-and-rear direction,
wherein in a case in which the pinching detection unit detects pinching and the seating detection unit does not detect seating of the occupant, the second control unit moves the backrest portion in a reverse direction by a predetermined angle, and
wherein in a case in which the pinching detection unit detects pinching and the seating detection unit detects seating of the occupant, the second control unit moves the backrest portion in the reverse direction by an angle smaller than the predetermined angle.

4. A seat control method that is a control method of an electric seat that is configured to automatically move to a target position based on a predetermined operation, the seat control method comprising:
detecting pinching of an object occurring while the seat is moving;
detecting whether or not an occupant is seating on the seat;
moving the seat in a reverse direction by a predetermined amount in a case in which pinching is detected and seating of the occupant is not detected; and
moving the seat in the reverse direction by an amount smaller than the predetermined amount in a case in which pinching is detected and seating of the occupant is detected.
